(19) United States
(12) Patent Application Publication
(10) Pub. No.: US 2009/0194307 A1
(43) Pub. Date: Aug. 6, 2009

(54) Torque limiting driver and method

(76) Inventor: James A. Rinner, Franksville, WI (US)

Correspondence Address: Arthur J. Hansmann, 5200 Washington Ave., Racine, WI, 53406, US

(21) Appl. No.: 11/664,248

(22) PCT Filed: Dec. 28, 2005
(86) PCT No.: PCT/US05/46766

§ 371 Date: Mar. 29, 2007

(51) Int. Cl. B23Q 5/00; B25B 13/22

(52) U.S. Cl. 173/181; 81/145

(57) ABSTRACT

A rotation driver and method for transmitting a limit torque to a fastener by having cam members which rotate together for torquing and then reverse the rotation to return to their starting position for repeating the torquing. The same two surfaces respectively on the two cam members always contact only each other for the torquing. There is lost motion between the cam members at the end of the limit torquing, and there can be further application of torque beyond the limit. A calibration adjuster urges the cam members together, and a lock arrangement secures the adjuster in its calibrated position. Also, there can be drive rotation in the direction reverse from the limit torque application.

This invention relates to a torque limiting driver and method, and, more particularly, it relates to a driver and method for rotating threaded fasteners.

### BACKGROUND OF THIS INVENTION

Torque limiting drivers are already known in the prior art. However, they require frequent attention and re-calibration in order to maintain the desired torquing action. Even then, they do not produce accurate torque limits in preferred precision. The prior art drivers commonly have a ten percent deviation from their desired torque specification, and they can need re-calibration perhaps every six months, depending upon usage.

The present invention improves upon the prior art drivers in that it provides a driver that substantially reduces the inaccuracy and the need for re-calibration. There also is an improvement in manufacturing the driver to thereby achieve the improved tolerances and durability. The setting of the adjustable parts for calibration is easily accomplished, and the parts are firmly secured in the desired calibrated setting. Further, there is a lesser impact, and thus avoidance of damage and upset of calibration, of the driver parts when the limit torque is reached. Also, there is a reduction or even elimination of any requirement for lubrication.

This invention is susceptible to being employed in either a handle or an adapter from which the rotation is transferred to the fastener. Also, while there are a plurality of matching paired cam surfaces, the same two cam surfaces always pair exclusively only with each other, and thus there are the advantages mentioned, including being able to produce exact matching pairs of cams.

The driver, and its method of operation, also gives the user a feel and sensitivity for applying the torque and, with an ample time interval, there is provision for the user to sense when the torque has reached its desired limit. When the torque limit is reached, the user has the options of either further rotating the driver at that limit, so the user need not immediately stop the driving rotation, so instead the user can rotate even further and thereby apply torque beyond the calibrated amount, if so desired, or the user can allow the driver to reset itself for another application of the limited torque, for instance for another fastener. Also, there can be reverse rotation drive onto a driving shaft and thence to the fastener.

### BRIEF DESCRIPTION OF THE DRAWINGS

FIG. 1 is a rear perspective view of a driver of this invention.

FIG. 2 is a side elevation view of FIG. 1.

FIGS. 3 and 4 are respectively left end and right end elevation views of FIG. 2.

FIG. 5 is a side bottom plan view of FIG. 2.

FIG. 6 is an enlarged section view taken on a plane designated by the line 6-6 of FIG. 5.

FIG. 7 is an exploded perspective view of the driver shown in FIG. 6, on a reduced scale, and showing the driver internal parts.

FIG. 8 is a perspective view of a part shown in FIG. 7 but from the opposite end thereof.

FIGS. 9 and 10 are respectively top plan and front side elevation views of FIG. 8.

FIG. 11 is a left end elevation view of FIG. 10.

FIG. 12 is section view taken on a plane designated by the line 12-12 of FIG. 11.

FIG. 13 is a perspective view of a part shown in FIG. 7 but slightly rotated and enlarged.

FIGS. 14, 15, and 16 are elevation views respectively of the left side, front, and right side of FIG. 13, but slightly rotated therefrom.

FIGS. 17 and 18 are perspective views of a part shown in FIG. 7, but on an enlarged scale.

FIGS. 19, 20, and 21 are elevation views respectively of the left side, front, and right side of FIG. 17.

FIGS. 22 and 23 are perspective views of a part shown in FIG. 7, but on an enlarged scale.

FIGS. 24, 25, and 26 are elevation views respectively of the left side, front, and right side of FIG. 22.

FIGS. 27 and 28 are respectively perspective and front elevation views of a part shown in FIG. 7, but on an enlarged scale.

FIGS. 29, 30, and 31 are respectively perspective, front elevation, and left side elevation views of a part shown in FIG. 7, but on an enlarged scale.

FIG. 32 is a perspective view of a part shown in FIG. 6, but on a reduced scale.

FIGS. 33, 34, and 35 are respectively front, left end elevation, and right end elevation views of FIG. 33.

FIG. 36 is a section view taken on a plane designated by the line 36-36 of FIG. 33.

FIG. 37 is a side elevation view of another embodiment of this invention.

FIG. 38 is an enlarged section view taken on a plane designated by the line 38-38 of FIG. 37.

FIG. 39 is a left end perspective view of an interior portion of FIG. 38, but on a reduced scale.

FIGS. 40 and 41 are respectively left end elevation and right end elevation views of FIG. 37.

FIG. 42 is an exploded view of FIG. 38, on a reduced scale and taken from the left end of FIG. 38.

FIG. 43 is a section view of a part shown in FIG. 42 and taken on a plane designated by the line 43-43 in. FIG. 42.

FIGS. 44 and 45 are respectively enlarged perspective and right end views taken from the right end of FIG. 41.

FIGS. 46 and 47 are respectively enlarged perspective and right end elevation views taken from the right end of FIG. 41 and showing a rotated position different from that shown in FIGS. 44 and 45.

FIGS. 48, 49, and 50 are respectively perspective, side elevation, and top plan views of a part shown in FIG. 6, but on an enlarged scale.

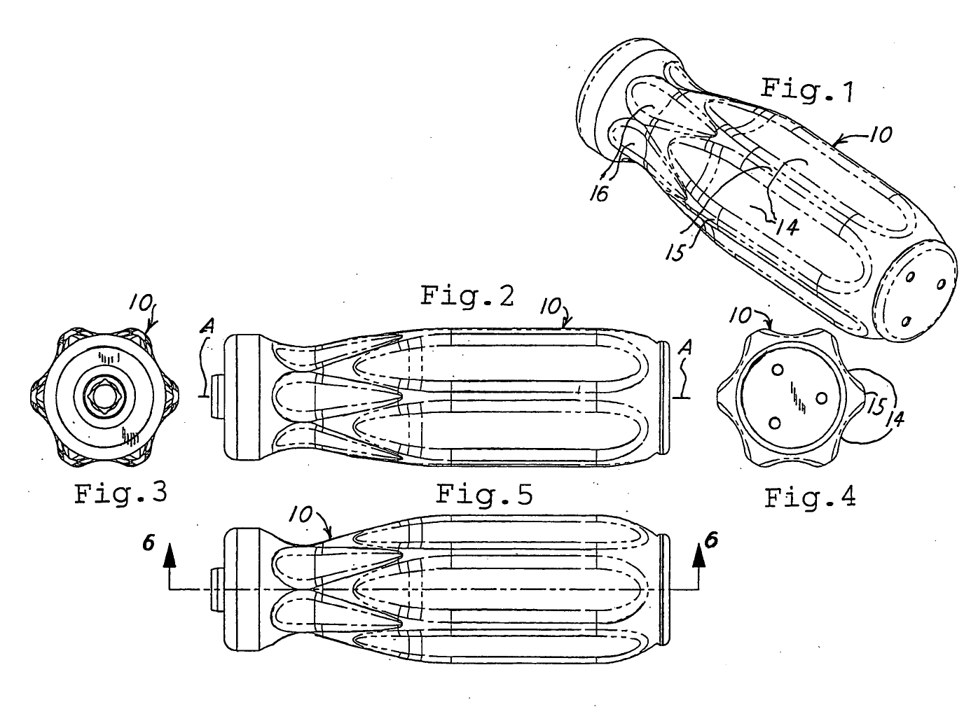

### DETAILED DESCRIPTION OF DRIVER AND METHOD

Drawing sheets one, two, and three show a driver handle 10 including a unitized cylindrical sleeve 11 and a casing 12 suitably affixed to the sleeve 11. The handle presents a formed hollow interior 13 and it extends along a longitudinal axis A. The outer casing 12 has depressions 14 and lobes 15, for being gripped by the user's hand, and it has depressions 16 for receiving the user's thumb. Thus the user can rotate the handle 10 about the axis A for rotationally driving conventional but unshown threaded fasteners, such as nuts and screws, but driving them only to a desired limited torquing force.

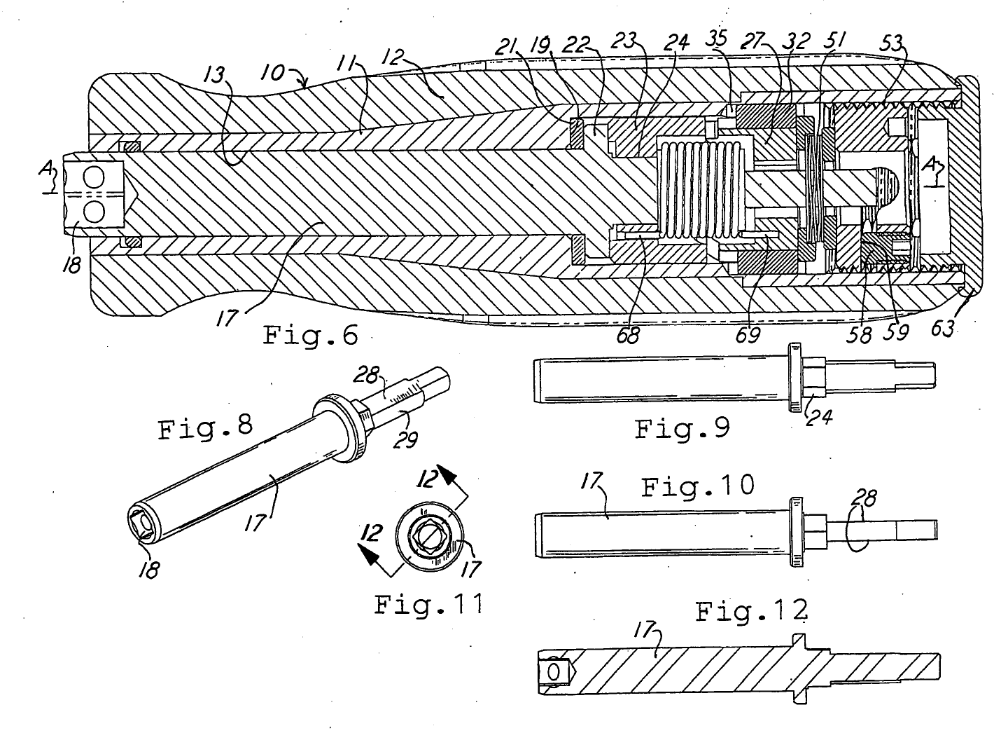

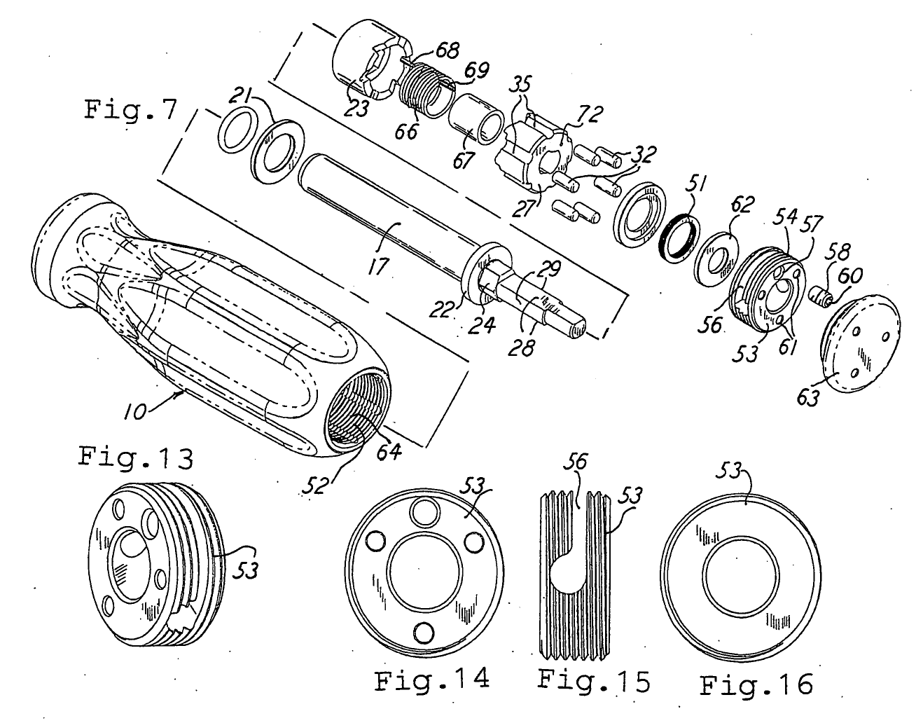

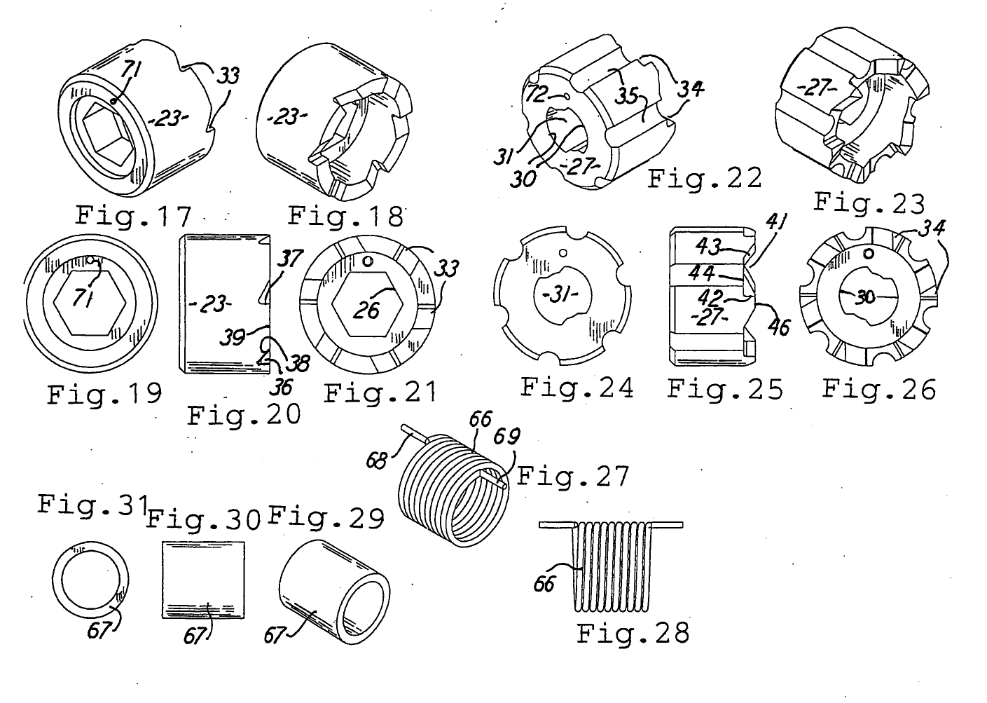

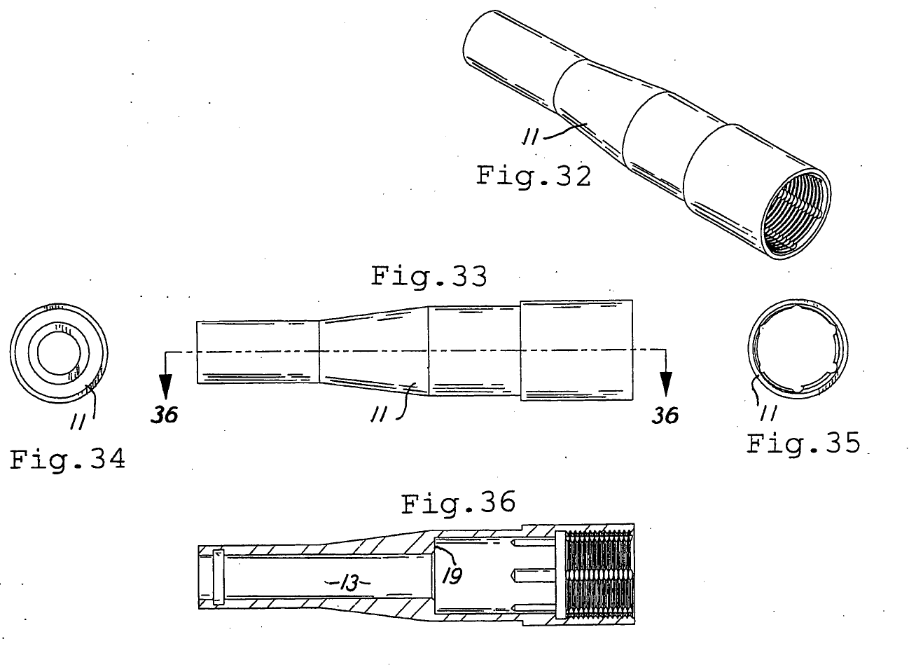

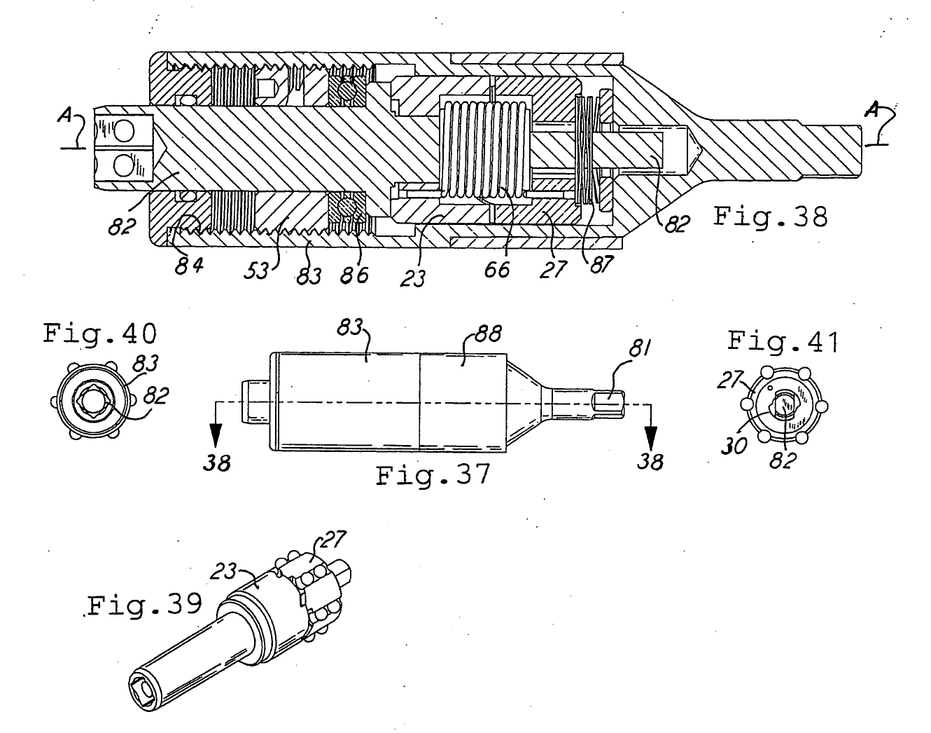

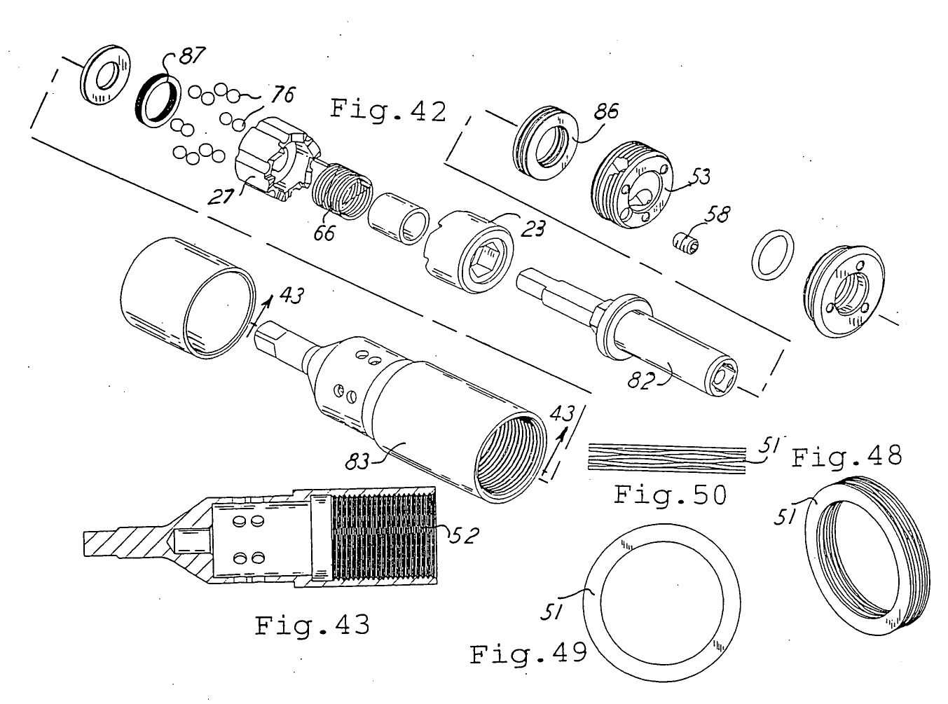

An elongated cylindrical shaft 17 is disposed within the sleeve 11 and extends along the axis A, as seen on sheets two and five, and the shaft 17 is rotatable about the axis A within the handle 10. Shaft 17 has a left end 18, as viewed in FIG. 6, which is suitable for engaging an unshown drive bit extender which in turn engages the unshown fasteners, all in the usual manner. The sleeve 11 has a shoulder 19, and there can be a washer 21 and a shaft flange 22, all of which limit the shaft 17 from moving leftward relative to the handle 10, as viewed in FIG. 6.

A cylindrical cam member 23 is mounted on the shaft 17, and the shaft has a hexagonal length 24 and the member 23 has a hexagonal bore 26, all arranged to have the shaft 17 and the member 23 rotate as a unit. Aligned and matched with the cam member 23 is a cam member 27 which is axially movable and limitly rotatable on the shaft 17. The shaft 17 has two diametrically opposite planar surfaces 28 at its length which disposed within the member 27. The shaft 17 and member 27 both have two diametrical opposite arcuate and respective sliding surfaces 29 and 30, with the surfaces 29 being of a lesser arc than that of the surfaces 30. Also, the member 27 has an irregularly shaped bore 31, as seen on sheets four 4 and eight. With the shapes mentioned, member 27 and shaft 17 have a relatively slidable and a rotation lost-motion connection therebetween.

Anti-friction means, such as rollers 32, are interposed between the member 27 and the handle 10 off the sleeve 11 to permit axial movement of the member 27 relative to the handle 10 and the shaft 17. Both the member 27 and the sleeve 11 have semi-circular and elongated grooves 35 to snugly receive respective arcuate portions of the rollers 32.

Sheet four shows that the members 23 and 27 have respective teeth 33 and 34 which face and engage each other and are for selective rotational drive engagement therebetween. Thus, upon engagement of the teeth 33 and 34 in response to leftward axial movement of the member 27, and upon rotation of the member 27, with rotation of the handle 10 and through rollers 32, rotational drive can be transmitted to member 23 and thus to the shaft 17 and then to the unshown fastener.

The teeth 33 are each shaped to have a recess 36 formed by the axially oriented surface 37 and by the slanted surface 38 disposed on a plane oblique to axis A. So surface 38 presents a cam abutment for rotation of the member 23 in the direction away from the facing direction of surface 38. There is a land of a flat or planar surface 39 disposed perpendicular to the axis A. The surface 38 is disposed to face in the rotation direction away from a right-hand fastener direction of tightening. There are a plurality of the teeth 33 disposed around the member 23, such as the six shown on sheet four, and they present exclusive matching pairs, always matching only with the same one.

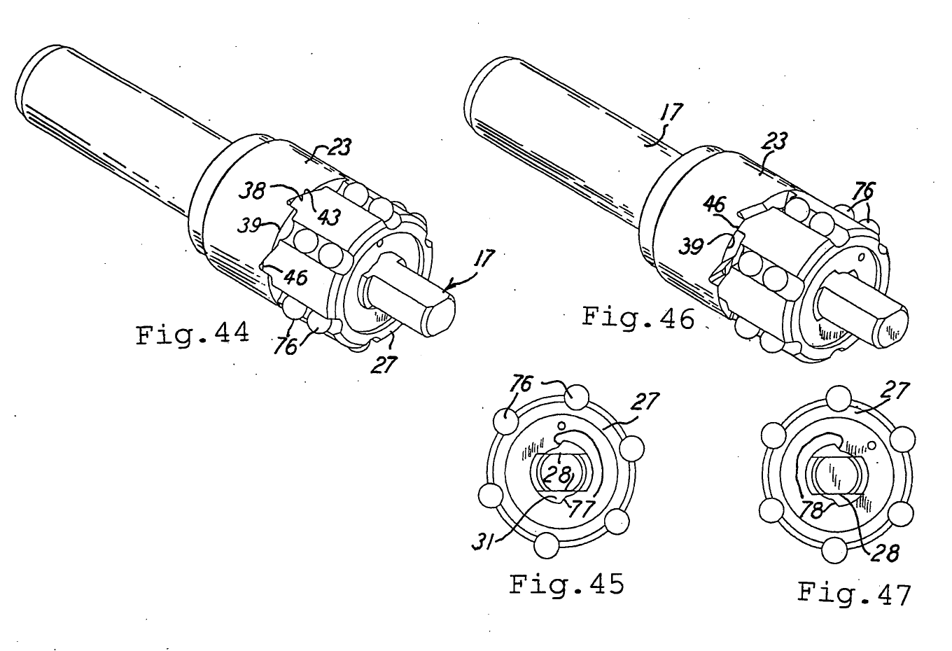

Teeth 34 have a shape to drivingly coordinate with the teeth 33, so there is a tooth recess 41 presented by the axially extending surface 42 and the slanted surface 43. Surfaces 42 and 43 respectively overlie and respectively face surfaces 37 and 38. There also is a flat or planar surface 44 presenting the teeth 34, and surface 44 can face the surface 39 and be on a plane perpendicular to the axis A. Member 27 also has a planar land 46 perpendicular to the axis A and which can take the position shown in FIG. 44.

For right-hand threaded fastener tightening, member 27 is rotated in the clockwise direction, from the right end axial view of the handle 10, and that causes the rotation keys, which are the rollers or like connectors, to likewise rotate the member 27. With the tooth oblique surface 43 in contact with the matching oblique surface 38, the member 23 will also rotate clockwise and in turn that will rotate the shaft 17 for tightening the fastener. Tightening continues until the surface 43 rotates beyond the surface 38 and to the land surface 39. That is the limit of torque transmitting, as desired. The user will then sense that the limit torque has been achieved, but there can be further rotation, whereupon the land surface 46 will slide on land surface 39. However, the surface 46 can not move rotationally beyond the surface 39, as explained later. In fact, as also explained later, upon the user releasing the handle 10, the member 27 will be rotated in the counterclockwise direction to have the member 27 return to its starting position relative to and mating with the member 23.

In the tightening action, member 23 transmits its rotation to the shaft 17 because of the hexagonal connection shown, and thus torque is applied to the fastener being tightened. The surfaces 43 and 38 serve as cams in that the surface 43 will force upon and slide along the surface 38, and the surface 46 will subsequently move to the land surface 39. At that time, the limit of the desired torque had been achieved and there can be no more application of torque and the member 23 stops rotating and will no longer apply tightening torque to the fastener, and the user will sense that and thereby know that the limit torque has been reached and the user can then release the handle 10 and the member 27 will then reverse its rotation and regain its initial position relative to the member 23, as more fully described later.

As shown, wave washer 51, or there could be any axial compression member employed, is positioned to force axially on member 27 and thereby exert the axial force to have the members 27 and 23 in the explained axial contact. Of course the rollers 32 are anti-friction members that allow the axial movement of the member 27. The handle 10 has a bore with threads 52, and an axial abutment calibration member 53 has threads 54 engaged with the handle threads 52. The member 53 can threadedly move axially in the handle toward and away from the compressor 51. Of course, that axial movement is according to the threaded adjustment made by the person threadedly setting the member 53 for the desired axial force on the member 27 and thus establish the desired torque limit of calibration for the driver.

To secure the adjuster 53 in its selected adjusted position, it has a radially extending gap 56 and an axially extending threaded hole 57. A set screw 58 is disposed in the threaded hole 57 and, when tightened in the member 53, the screw end abuts the member 53 at wall 59, as shown in FIG. 6. With the gap arrangement shown, the screw 56 itself is axially compressed to be secure in its adjusted position, and it serves as a lock for forcing the two ends of the member 53 away from each other and thus press the threads 54 against the handle threads 52. The adjuster 53 can be made of slightly resilient material, including metal, for flexing axially toward and away relative to the gap 56 and axial compression of the threads. Screw 58 has a tool connector at 60 for connecting to an unshown but conventional rotation tool which can be inserted into the handle end bore to contact the screw 58 and rotate the screw for the tightening mentioned. The adjuster 53 can have spanner holes 61 for receiving an unshown but conventional spanner wrench for calibration-screwing the adjuster along the handle bore 64 defined by the threads 52. A washer 62 is between the member 27 and the adjuster 53 for the axial thrust. A threaded end cap 63 is screwed into, and thus closes, the handle bore 64.

For returning the member 27 to its FIG. 3 rotated starting position of nesting with the member 23, there is shown an axially extending torsion spring 66 guided by a spacer 67 for spring alignment. End extensions 68 and 69 of the spring 66 respectively extend into receptor holes 71 and 72 respectively in members 23 and 27, and the spring ends 68 and 69 thereby contact the members 23 and 27 for exerting the rotational force between the two members 23 and 27 and thereby rotate the member 27 back to its aforementioned starting position. It should be understood that any conventional means can be employed for exerting the axial compression and the return rotation mentioned above.

When the spring 66 is assembled herein, it can be loaded to a predetermined torsion load that is lower than the target load of the assembled driver but is high enough to cause the member 27 to return to the starting position and its engagement with member 23 prior to the next torque cycle. The spring 66 exerts a preloaded amount of rotation tension on the cam members 23 and 27 and thereby prevents a sudden release of load when the member 27 is returned to its starting position. So there is no shock impact on the driver to upset the calibration when the parts return to their starting positions. The load exerted by the spring 66 will have no effect on the cam action of the members 23 and 27 because they relate to axial movement of the member 27, while the spring 66 relates only to the relative rotated positions of the members 23 and 27.

In that reverse rotation return action, the surface 46 will be in contact with and slide upon the surface 39, and subsequently the surface 43 will contact and slide upon the surface 38, all for the return to the position of FIG. 44. As such, there is no impact between the members 23 and 27 upon returning to the start position.

FIGS. 45 and 47 show a lost motion rotation connection between the handle 10 and the shaft 17. FIGS. 44 and 45 show the rotational starting position for torque application, and FIGS. 46 and 47 show the rotational end position of the lost motion relationship. In these four views, there are balls 76 which replace the rollers 32, and the balls 76 readily facilitate the axial motion of the member 27 during the application of torque while still transmitting the desired rotation motion between the handle 10 and the member 27. With the two diametrically opposite concave surfaces 30 on the member 27 and the shaft arcuate surfaces 29, the member 27 rotates on the shaft 17 between the two positions shown in FIGS. 44-47 if and when the user rotates the handle 10 to where the surface 46 slides on the surface 39. That is when there is no more fastener tightening torque being transmitted between the members 23 and 27 because the desired torque has already been applied.

However, the member 27 has four interior shoulders 77 and 78 facing circumferentially and in interference fit with the shaft flats 28. The user can apply rotation to the handle 10 beyond the limit torque, and that causes the shoulders 77 to rotationally drive-engage the shaft 17, as in the position shown in FIGS. 46 and 47. At that condition, the member surface 46 remains on the member surface 39 and never rotates therebeyond in the driving direction. The user's release of the handle 10 then has the spring 66 return the member 27 to its starting position of FIGS. 44 and 45. Therefore, the driver always has the same two paired cam surfaces 38 and 43 in driving contact, rather than have the driver advance to a rotated position where two other cam surfaces would mate with each other. So the cam surfaces are always paired with the same two surfaces, and thus the advantages of this driver.

The rotation degree of lost motion with shoulders 77 is less that the maximum degree of rotation of the surface 46 on the land 39, so the cam members never can rotate to where the same two paired cam surfaces 38 and 43 would not be repeatedly matched as a pair. The shoulders 78 serve as alignment stops for the spring 66 to return the member 27 to its starting position of FIGS. 44 and 45. So the amount of angular rotation between the FIG. 45 and FIG. 47 positions is less than the amount of angular rotation between the teeth as shown in FIG. 44 to FIG. 46 where the surface 46 is still on the surface 39 while the shoulder 77 is in rotation drive with the surfaces 77 on the shaft 17, as in FIG. 47. So the angular lost motion between the handle 10 and the shaft 17 is less than the angular lost motion between the non-torquing surfaces 39 and 46 of the teeth 33 and 34.

When applying torque, the cam 43 slides on the cam 38 inducing rotation of the member 23 and the tightening of the unshown fastener, all in proportion to the increasing axial force exerted by the compression member 51. Likewise, the shoulders 78 will rotate off the shaft flats 28 toward the FIG. 47 position. The geometry of the teeth 33 and 34, such as the degree of oblique angulation for camming action and the sliding friction therebetween, and the strength of the spring 51, can be such that full limit torque can have been applied upon reaching the FIG. 47 abutting position. Also, there can be reverse rotation when in the FIG. 45 start position because the shoulders 78 can be in rotation drive on the shaft flats 28, and also the teeth surfaces 42 and 37 can be in mutual reverse driving contact.

Drawing sheets 6 and 7 show another embodiment of the invention, and here there is a shown an adapter instead of the handle 10. Thus a suitable rotation drive member could be connected to an end 81 of a shaft 82, which is a modified shaft 17. The adapter has a cylindrical housing 83 which has a threaded bore 84 for receiving a thrust washer 86 and the adjuster 53. In this arrangement, the calibration adjustment axial force is applied from left to right, as viewed in FIG. 38, and there is the axial reaction force applied by a wave spring 87. A sleeve 88 fits snugly over the shown assembly and it retains the transmission balls 76 which extend into the grooves 35 in the member 27 for the rotation drive and the axial movement of the member 27.

In both these embodiments, the handle 10 and the member 83 are housings for the internal parts disclosed, and they both present the axis A and the housing threads 52 for the adjuster 33, and they both have the rotation drive connection to the member 27 and in turn to the shafts 17 and 82, with the lost motions disclosed, including that seen in FIG. 41.

The initial position is shown in FIG. 44, and it shows surface 43 to be circumferentlally longer than that of surface 38. Also, the surface 46 is spaced from the surface 38, so the cam surfaces 38 and 43 are in contact with each other in the initial position. Upon release of the housings 10 or 83 for returning to the initial position after applying torque to the position of FIG. 46, the surface 46 slides on the surface 39 until the surfaces 43 and 38 come into contact with each other. The members 23 and 27 can be stopped in that reverse rotation by their respective shoulders 37 and 42, and also by the shoulders 77 engaging the shaft flats 28, as in FIG. 45. There is no impact between the camming surfaces when regaining the initial position.

The foregoing description also disclosed the method of applying the limit torque. It also discloses the method of regaining the starting positions of the working parts, that is by the user releasing the turning torque on the handle 10 or the adapter at 83. Those method steps have been fully explained in the foregoing and with regard to both embodiments of this invention.

1. In a torque limiting rotation driver for tightening a threaded fastener, a housing (10, 83) having a hollow interior (13, 84) and extending along an axis (A), a shaft (17, 82) rotatable in said housing, two cam members (23, 27) on said shaft for transmitting rotation drive in a first rotation direction about axis A and from said housing to a first one (27) of said cam members which then transmits rotation to a second one (23) of said cam members which then transmits rotation to said shaft and then to the fastener, each of said cam members having a rotation driving respective surface (43, 38) in initial contact with each other for the transmission of the rotation torque and with said driving surfaces being relatively rotatable about axis A to apply a limited torque to the fastener, first spring moans (51, 87) with spring force along said axis for yieldingly urging said rotation driving surfaces into the initial contact, the improvement comprising:
second spring means (66) separate from and in addition to said first spring means and being operative on said first cam member only for rotation of said first cam member and only in a rotation direction reverse from said first rotation direction and for returning said driving surfaces to the initial contact, position and thereby reset said driving surfaces for a repeat application of the limited torque.

2. The torque limiting rotation driver, as claimed in claim 1, further comprising:
said first cam member (27) and said shaft (17, 82) have a rotation lost motion relationship therebetween whereby said housing can rotate beyond the position of the full application of the limit torque while said second cam member (23) does not rotate, and
a stop (28, 77) effective between said first cam member and said shaft for limiting said rotation lost motion.

3. The torque limiting rotation driver, as claimed in claim 1, further comprising;
said first one (27) of said cam members (23, 27) and said shaft (17, 82) have a rotation lost motion relationship therebetween whereby said first cam member (27) can rotate beyond the rotation of said shaft subsequent to the application of said limited torque, and
said first one (27) of said cam members (23, 27) and said shaft (17) have a rotation drive connection (77, 28) mutually engageable therebetween to be operative subsequent to the rotation lost motion therebetween for rotatably driving said shaft.

4. The torque limiting rotation driver, as claimed in claim 1, further comprising:
said first one (27) of said cam members (23, 27) and said shaft (17, 82) have a rotation lost motion relationship herebetween whereby said first cam member (27) can rotate beyond the rotation of said shaft subsequent to the implication of said limited torque,
said cam members have a rotation lost motion relationship therebetween, and
the maximum rotation lost motion between said cam members (23, 27) is greater in angular degrees of rotation than the maximum rotation lost motion in angular degrees of rotation between said first cam member (27) and said shaft (17, 82).

5. The torque limiting rotation driver, as claimed in claim 1, further comprising:
said first member (27) and said shaft (17, 82) having a stop (78) therebetween operative in the rotation direction reverse from the rotation direction of applying a torque.

6. In a torque limiting rotation driver for tightening a threaded fastener, a housing (10, 83) having a hollow interior (13, 84) and extending along an axis (A), a shaft (17, 82) rotatable in said housing, two cam members (23, 27) on said shaft for transmitting rotation drive in a first rotation direction about axis A and from said housing to a first one (27) of said cam members which then transmits rotation to a second one (23) of said cam members which then transmits rotation to said shaft and then to the fastener, said first can member and said shaft having a rotation lost motion relationship therebetween, each of said cam members having a rotation driving respective surface (43, 38) in initial contact with each other for the transmission of the rotation torque and with said driving surfaces being relatively rotatable about axis A to apply a limited torque to the fastener, first spring means (51, 87) with spring force along said axis for yieldingly urging said rotation driving surfaces into the initial contact, the improvement comprising:
said cam members having a rotation lost motion relationship therebetween which is greater in angular degrees of rotation than the maximum rotation lost motion in angular degrees of rotation between said first cam member (27) and said shaft (17, 82) and thereby limit rotation of said cam members relative to each other.

7. The torque limiting rotation driver as claimed in claim 6, the improvement comprising;
a member (66) operative on said first cam member for rotation of said first cam member in a direction reverse from said first rotation direction and thereby return said driving surfaces to the initial contact position and reset said driving surfaces for a repeat application of the limited torque.

8. The torque limiting rotation driver as claimed in claim 7, the improvement comprising:
said member (66) is a torsion spring operative on both said cam members for rotation of said first cam member (27) in a direction reverse from the rotation drive direction.

9. In a torque limiting rotation driver for tightening a threaded fastener, two cam members (23, 27) supported for mutual movement toward and away from each other and having teeth (33, 34) and adjacent surfaces (46, 39) respectively thereon and mutually engageable for driving rotation of said cam members and relative to each other and for forming profiles on said cam members, said cam members rotation being in a first direction of rotation from an initial starting position for transmitting torque from a first one (27) of said cam members to a second one (23) of said cam members and to a completion position for the fastener tightening and only to a limited torque, the improvement comprising:
said teeth being engaged in pairs and said profiles on respective ones of said cam members being different in shape from said profiles on the other of said cam members for limited rotation lost motion drive therebetween and for further rotation lost motion therebetween subsequent to the rotation drive therebetween and with said profiles being shaped relative to said limited rotation lost motion and within the limited torque tightening to have said pairs of said teeth regain their engaged paired relationship with each application of limited torque.

10. In a torque limiting rotation driver for tightening a threaded fastener, a shaft (17, 82) connectable with the fastener for applying torque onto said fastener, two cam members (23, 27) supported for mutual movement toward and away from each other and for rotation together and relative to each other, said cam members rotation being in a first direction of rotation from an initial starting position and having rotation drive first respective surfaces (38, 43) for transmitting torque from a first one (27) of said cam members to a second one (23) of said cam members and to a torque-limit completion position for the fastener tightening and only to a limited torque, the improvement comprising:
one (27) of said cam members and said shaft having second said respective rotation drive surfaces (77, 28) in addition to said first respective surfaces (38, 43) for applying rotation drive beyond the limit torque drive.

11. The torque limiting rotation driver, as claimed in claim 10, further comprising:
a torsion spring (66) operative on said first one of said cam members after the application of the limit torque and for rotation of said first one of said cam members in a direction reverse from said first rotation direction and thereby return said cam members to said initial starting position.

12. In a torque limiting rotation driver for tightening a threaded fastener, a housing (10, 83) having a hollow interior and extending along an axis (A), a shaft (17, 82) connectable with the fastener for applying torque onto said fastener and being rotatably disposed in said housing, two cam members (23, 27) on said shaft and being supported for mutual movement toward and away from each other and for rotation together and relative to each other, said cam members rotation being rotatable in a first direction of rotation from an initial starting position for transmitting torque from a first one (27) of said cam members to a second one (23) of said cam members and to a torque-limit completion position for the fastener tightening and only to a limited torque, resilient means (51, 87) for urging said cam members toward each other for rotating together, a cylindrically shaped adjuster (53) threadedly selectively movably supported by said housing and operative on said cam members for exerting selective amounts of force on said cam members and thereby establish the amount of torque transmitted between said cam members, the improvement comprising:
said adjuster having a radially extending gap (56) therein defining two portions of said adjuster and said adjuster having a lock screw (58) extending across said gap for forcing said portions away from each other and thereby compressing the threads (54) of said adjuster into selective secured relationship with said housing.

13. The torque limiting rotation driver, as claimed in claim 12, further comprising:
said adjuster and said lock screw both having respective tool-receiving accommodations (61, 60) thereon and said housing has an open bore (64) adjacent said adjuster and said lock screw for access by a respective tool for respectively rotating said adjuster and said lock screw to their respective secured relationship with said housing.

14. In a method for rotationally transmitting a limit torque, rotating a, housing (10, 83) about an axis (A), rotatably supporting a shaft (17, 82) in said housing, transmitting the housing rotation between two cam members (23, 27) from a first position to a second position by applying a first spring (53, 87) along said axis for applying a torque up to the limited amount, forcing said cam members together along the axis and with an adjuster (53) for transmitting the torque therebetween, the improvement comprising the step of:
applying a second spring (66) to a first one (27) of said members and thereby reversing the direction of rotation of said first one (27) of said cam members for returning said first one of said cam members to said first position and thereby set said cam members for an application of the limited torque.

15. The method for rotationally transmitting a limit torque, as claimed in claim 14, comprising the further step of:
applying through said cam members in the second position a torque greater than the limit torque and after applying the limit torque.

16. The method for rotationally transmitting a limit torque, as claimed in claim 15, comprising the further step of:
applying an adjuster (53) and thereby forcing said cam members together and applying a releasable lock (58) on said adjuster for securing said adjuster in position to hold said cam members together.

17. The method for rotationally transmitting a limit torque, as claimed in claim 14, comprising the further step of:
rotating said one (27) cam member relative to the other (23) cam member after applying the limit torque and doing so in the direction of applying the limit torque, for producing a lost-motion rotation between said cam members.

18. In a torque limiting rotation driver for tightening a threaded fastener, a shaft (17, 82) connectable with the fastener for applying torque onto said fastener, two cam members (23, 27) supported for mutual movement toward and away from each other and for rotation together and relative to each other, said cam members rotation being in a first direction of rotation from an initial starting position and having rotation drive first respective surfaces (38, 43) for transmitting torque from a first one (27) of said cam members to a second one (23) of said cam members and to a torque-limit completion position for the fastener tightening and only to a limited torque, the improvement comprising:
said cam members having additional respective surfaces (39, 46) of lengths different from each other and being disposed on a common plane perpendicular to said axis A, and contiguous with said driving surface (43, 38) for sliding on each other.

19. The torque limiting driver as claimed in claim 18, the improvement further comprising:
said first one of said cam members having the shorter one of said different lengths.

20. The torque limiting driver as claimed in claim 18, the improvement further comprising;
said first one of said cam members and said shaft have a rotation lost motion relationship therebetween whereby said first cam member can rotate beyond the rotation of said shaft subsequent to the application of said limited torque, and
said longer one (39) of said different lengths being greater in total rotational contacting relationship of said additional surfaces than the total rotational lost motion relationship between said first cam member (27) and said shaft.
